(19) United States
(12) Patent Application Publication
(10) Pub. No.: US 2025/0246773 A1
(43) Pub. Date: Jul. 31, 2025

(54) SECONDARY BATTERY

(71) Applicant: SAMSUNG SDI CO., LTD., Yongin-si (KR)

(72) Inventor: Hwa Woo LEE, Suwon-si (KR)

(21) Appl. No.: 19/038,831

(22) Filed: Jan. 28, 2025

(30) Foreign Application Priority Data
Jan. 29, 2024 (KR) 10-2024-0013044

(51) Int. Cl. H01M 50/534

(52) U.S. Cl. CPC H01M 50/534

(57) ABSTRACT

Disclosed is a secondary battery capable of maintaining electron mobility when cracks are formed in an electrode of the secondary battery. The secondary battery includes a current collector, an active material layer formed on a portion of the current collector, a tab attached to another portion of the current collector, and a reinforcing layer disposed on the current collector while covering at least a portion of the tab, The reinforcing layer includes a conductive layer comprising a conductive material.

### CROSS-REFERENCE TO RELATED APPLICATION

The present application claims priority to and the benefit of Korean Patent Application No. 10-2024-0013044, filed on Jan. 29, 2024, in the Korean Intellectual Property Office, the entire disclosure of which is incorporated herein by reference.

### FIELD OF THE DISCLOSURE

The present disclosure relates to a secondary battery including a tab.

### DESCRIPTION OF THE RELATED ART

A secondary battery can be charged and discharged, unlike a primary cell that cannot be charged. Low-capacity secondary battery cells are used in small, portable electronic devices, such as smartphones, feature phones, notebook computers, digital cameras, and camcorders. High-capacity battery cells are widely used as power sources for motors in hybrid and electric vehicles and as power storage cells. Such a secondary battery includes an electrode assembly including a cathode and an anode, a case receiving the electrode assembly, and electrode terminals connected to the electrode assembly. A secondary battery also includes tabs extending from the electrode assembly and collecting electricity when the secondary battery is charged and discharged. For example, the tab is attached to a portion of the electrode assembly and extends therefrom.

Continuous stress can be applied to electrodes adjacent to the tabs due to large volume expansion upon repeated charge and discharge. The stress can cause cracks to be generated in the electrodes, causing disconnection of a migration path for electrons participating in intercalation and/or deintercalation of lithium ions from the electrodes. As a result, efficient migration of electrons from the electrodes to the tabs cannot be provided. Thus, there may be an increase in resistance and/or a decrease in output power in the secondary battery. Further, there may be a loss of utility or heat generation that can cause a fire in the secondary battery.

This section is intended only to provide a better understanding of the background of the disclosure and may include information which is not necessarily prior art.

### SUMMARY OF THE DISCLOSURE

It is one aspect of the present disclosure to provide a secondary battery that provides a migration path for electrons to an electrode in which cracks can be generated. This and other aspects and features of the present disclosure will become apparent from the following description of embodiments of the present disclosure.

In accordance with one aspect of the present disclosure, a secondary battery includes: a current collector; an active material layer formed on a first portion of the current collector; a tab attached to a second portion of the current collector; and a reinforcing layer disposed on the current collector while covering at least a portion of the tab, wherein the reinforcing layer includes a conductive layer comprising a conductive material.

In accordance with another aspect of the present disclosure, a secondary battery includes: an electrode assembly formed by stacking an electrode and a separator; a tab protruding from a side of the electrode; a reinforcing layer disposed on the electrode, with the reinforcing layer covering at least a portion of the tab; an electrode lead connected to the tab; and a case accommodating the electrode assembly, wherein the reinforcing layer includes a conductive layer comprising a conductive material; the electrode includes a current collector and an active material layer formed on a first portion of the current collector, and the tab is attached to a second portion of the current collector and extends from the electrode assembly.

According to the present disclosure, the secondary battery maintains output power without losing electronic conductivity when cracks are formed in an electrode.

According to the present disclosure, the secondary battery maintains output power and utility for a longer period of time.

According to the present disclosure, there is a reduced possibility of a fire in the secondary battery.

However, aspects and features of the disclosure are not limited to those described above and other aspects and features not mentioned will be clearly understood by those skilled in the art from the detailed description given below.

### BRIEF DESCRIPTION OF THE DRAWINGS

FIG. 1 to FIG. 4 are cross-sectional views of lithium batteries according to embodiments of the present disclosure.

FIG. 5 is a diagram of an electron migration in a cracked electrode.

FIG. 6 is a schematic view of a secondary battery according to an embodiment of the present disclosure.

FIG. 7 is a schematic view of an electron migration path according to an embodiment of the present disclosure.

FIG. 8A to FIG. 8C are schematic views of secondary batteries according to embodiments of the present disclosure.

FIG. 9 is a schematic cross-sectional view of a reinforcing layer according to an embodiment of the present disclosure.

FIG. 10 is a schematic cross-sectional view of an electrode, a tab, and a reinforcing layer according to an embodiment of the present disclosure.

### DETAILED DESCRIPTION OF THE DISCLOSURE

Hereinafter, exemplary embodiments of the present disclosure will be described in detail with reference to the accompanying drawings. However, it should be understood that the following embodiments are provided only for illustration and the present disclosure is not limited thereto.

When an element is referred to as being disposed (or placed or placed) “above” (or “below”) or “on” (or “under”) a component, it may mean that the arbitrary element is placed in contact with the upper (or lower) surface of the component and may also mean that another component may be interposed between the component and any element disposed (or placed or placed) on (or under) the component

Throughout the specification, unless specified otherwise, each element may be singular or plural. In addition, throughout the specification, when “A and/or B” is stated, it means A, B or A and B, unless specified otherwise.

As used herein, “combinations thereof” may refer to mixtures, stacks, composites, copolymers, alloys, blends, and reaction products of components.

Unless otherwise defined herein, particle diameter refers to an average particle diameter. In addition, the particle diameter means an average particle diameter (D50) corresponds to 50% by volume in a volume cumulative variation of corresponding particles. The average particle diameter may be measured by any method well known in the art, for example, by a particle size analyzer, a transmission electron microscope image, or a scanning electron microscope image. Alternatively, the average particle diameter (D50) may be measured by counting the number of particles in each particle diameter range using a device employing a dynamic light-scattering method to analyze data, followed by calculating the average particle diameter (D50) based on the analyzed data. Alternatively, the average particle diameter (D50) may be measured by laser diffraction. More specifically, in measurement by laser diffraction, target particles are dispersed in a dispersant, introduced into a commercially available laser diffraction particle analyzer (for example, Microtrac MT 3000), and irradiated with ultrasound waves of about 28 kHz at a power of 60 W, followed by calculating the average particle size (D50) corresponding to 50% by volume in the cumulative volume variation of the particles in the measurement device.

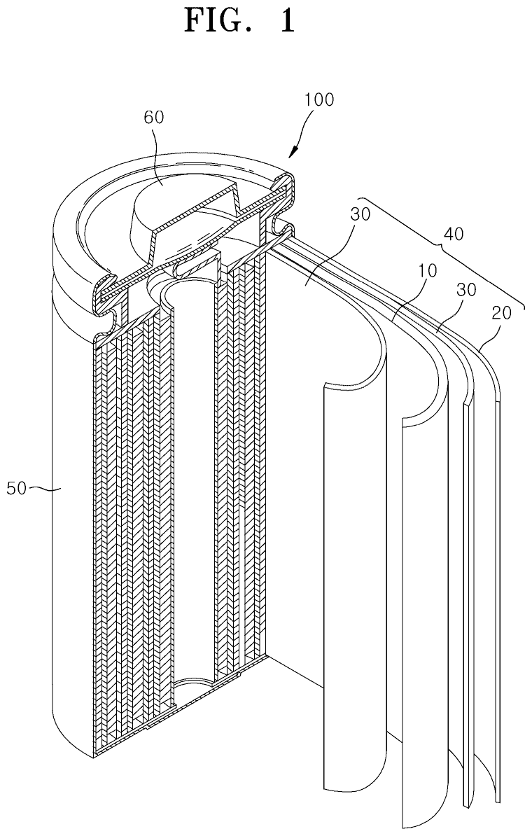

FIG. 1 to FIG. 4 are cross-sectional views of lithium secondary batteries according to embodiments of the present disclosure.

### Lithium Secondary Battery 100

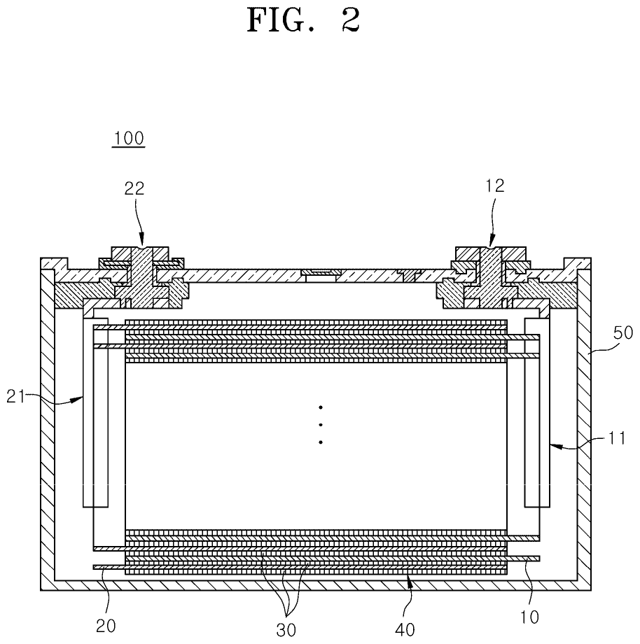

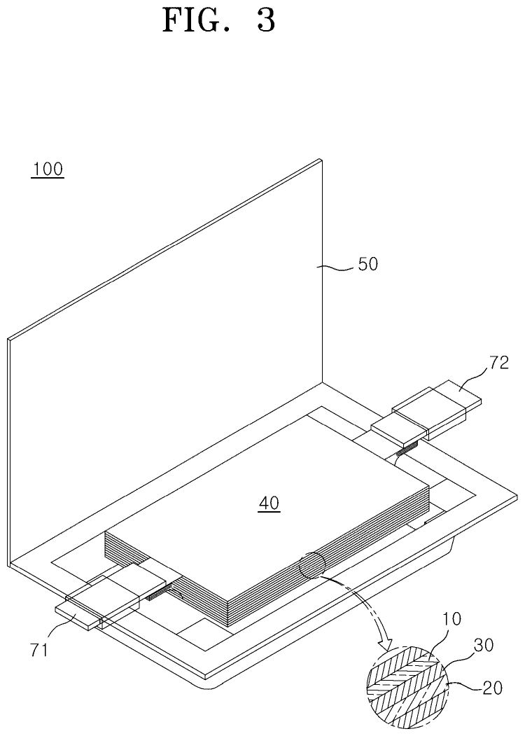

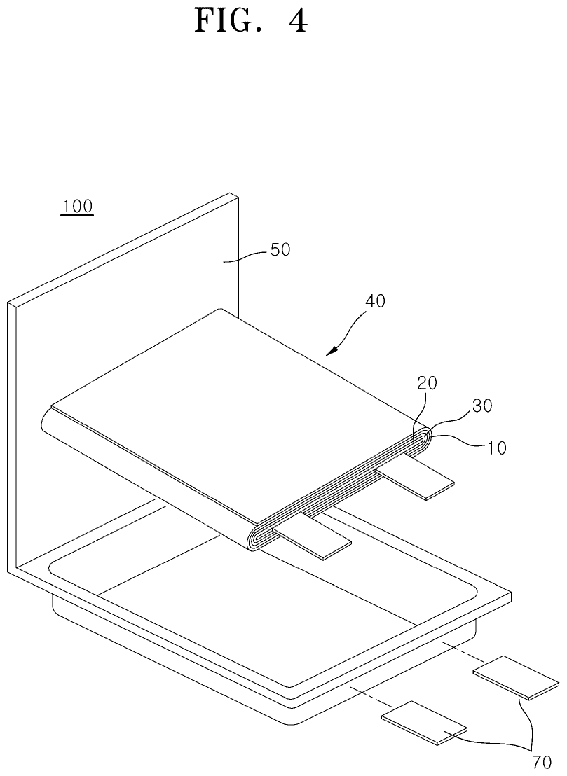

Lithium secondary batteries may be classified as a cylindrical secondary battery, a faceted secondary battery, a pouch type secondary battery, a coin type secondary battery, and the like based on their shape. FIGS. 1 to 4 are schematic views of lithium secondary batteries according to embodiments of the present disclosure. FIG. 1 shows a cylindrical secondary battery, FIG. 2 shows a faceted secondary battery, and FIG. 3 and FIG. 4 show pouch-type secondary batteries. Referring to FIGS. 1 to 4, a lithium secondary battery 100 may include an electrode assembly 40 in which a separator 30 is interposed between a cathode 10 and an anode 20, and a case 50 that receives the electrode assembly 40 therein. The cathode 10, the anode 20, and the separator 30 may be embedded in an electrolyte (not shown). As shown in FIG. 1, the lithium secondary battery 100 may include a sealing member 60 that seals the case 50. In addition, as shown in FIG. 2, the lithium secondary battery 100 may include a cathode lead tab 11, a cathode terminal 12, an anode lead tab 21, and an anode terminal 22. Referring to FIG. 3 and FIG. 4, the lithium secondary battery 100 may include electrode tabs 70, that is, a cathode tab 71 and an anode tab 72, which act as electrical pathways conducting current formed in the electrode assembly 40 to outside of the secondary battery.

### Cathode Material

As a cathode material, a compound allowing reversible intercalation and deintercalation of lithium (lithiated intercalation compound) may be used. Specifically, the cathode material may be at least one complex oxide of a metal selected from among cobalt, manganese, nickel and combinations thereof with lithium.

The composite oxide may be a lithium transition metal composite oxide. Specifically, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li _{(3-f)}Fe₂ (PO₄)₃ (0≤f≤2); and LiₐFePO₄ (0.90≤a≤1.8). In these formulas, A is Ni, Co, Mn, or a combination thereof; X is Al, Ni, Co, Mn, Cr, Fe, Mg, Sr, V, a rare-earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

In an embodiment, the cathode material may be a high nickel-content cathode material containing 80 mol % or more, 85 mol % or more, 90 mol % or more, 91 mol % or more, or 94 mol % to 99 mol % of nickel relative to 100 mol % of metal in the lithium transition metal complex oxide excluding lithium. The high nickel-content cathode material can achieve high capacity and, thus, can be used in high capacity/high density lithium secondary batteries.

### Cathode 10

The cathode 10 for the lithium secondary battery 100 may include a current collector and a cathode material layer formed on the current collector. The cathode material layer includes a cathode material and may further include a binder and/or a conductive material. In8 an embodiment, the cathode may further include an additive capable of acting as a sacrificial cathode.

The cathode material may be present in an amount of 90 wt % to 99.5 wt % based on 100 wt % of the cathode material layer and each of the binder and the conductive material may be present in an amount of 0.5 wt % to 5 wt % based on 100 wt % of the cathode material layer.

The binder serves to attach cathode material particles to each other while attaching the cathode material to the current collector. The binder may include, for example, polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinyl pyrrolidone, polyurethane, polytetrafluoroethylene, polyvinylidene fluoride, polyethylene, polypropylene, styrene-butadiene rubbers, (meth)acrylated styrene-butadiene rubbers, epoxy resins, (meth)acrylic resins, polyester resins, nylon, and the like. But the present disclosure is not limited to these examples.

The conductive material serves to impart conductivity to the electrodes and may be any electrically conductive material that does not cause chemical change in cells under construction. The conductive material may include, for example, carbon materials, such as natural graphite, artificial graphite, carbon black, acetylene black, Ketjen black, carbon fiber, carbon nanofibers, carbon nanotubes, and the like; metal-based materials in the form of metal powders or metal fibers containing copper, nickel, aluminum, silver, and the like; conductive polymers, such as polyphenylene derivatives and the like; and mixtures thereof.

The current collector may be aluminum, but the present disclosure is not limited thereto.

### Anode Material

The anode material includes a material allowing reversible intercalation/deintercalation of lithium ions, lithium metal, lithium metal alloy, a material capable of being doped to lithium and de-doped therefrom, or a transition metal oxide.

The material allowing reversible intercalation/deintercalation of lithium ions may include a carbon-based anode material, for example, crystalline carbon, amorphous carbon, or a combination thereof. The crystalline carbon may include, for example, graphite, such as natural graphite or artificial graphite, in amorphous, plate, flake, spherical, or fibrous form, and the amorphous carbon may include, for example, soft carbon, hard carbon, mesoporous pitch carbides, calcined coke, and the like.

The lithium metal alloy may be an alloy of lithium and a metal selected from among Na, K, Rb, Cs, Fr, Be, Mg, Ca, Sr, Si, Sb, Pb, In, Zn, Ba, Ra, Ge, Al and Sn may be used.

The material capable of being doped to lithium and de-doped therefrom may be an Si-based anode material or an Sn-based anode material. The Si-based anode material may be silicon, a silicon-carbon composite, SiOₓ (0<x<2), Si-Q alloys, or combinations thereof. In the formula Si-Q, Q is selected from among alkali metals, alkali-earth metals, Group XIII elements, Group XIV elements (excluding Si), Group XV elements, Group XVI elements, transition metals, rare-earth elements, and combinations thereof. The Sn-based anode material may be Sn, SnO₂, an Sn alloy, or a combination thereof.

The silicon-carbon composite may be a composite of silicon and amorphous carbon. According to an embodiment, the silicon-carbon composite may be prepared in the form of silicon particles having an amorphous carbon coating formed on the surfaces thereof. For example, the silicon-carbon composite may include secondary particles (cores) composed of primary silicon particles and an amorphous carbon coating layer (shell) formed on the surfaces of the secondary particles. The amorphous carbon may also be placed between the primary silicon particles such that, for example, the primary silicon particles are coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer formed on the core.

The Si-based anode material or the Sn-based anode material may be used in combination with the carbon-based anode material.

### Anode 20

The anode 20 for the lithium secondary battery 100 may include a current collector and an anode material layer formed on the current collector. The anode material layer includes an anode material and may further include a binder and/or a conductive material.

The anode material layer may include, for example, 90 wt % to 99 wt % of the anode material, 0.5 wt % to 5 wt % of the binder, and 0 wt % to 5 wt % of the conductive material.

The binder serves to attach the anode material particles to each other while attaching the anode material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from styrene-butadiene rubbers, (meth)acrylated styrene-butadiene rubbers, (meth)acrylonitrile-butadiene rubbers, (meth)acrylic rubbers, butyl rubbers, fluorinated rubbers, polyethylene oxide, polyvinyl pyrrolidone, polyepichlorohydrin, polyphosphazene, poly(meth)acrylonitrile, ethylene propylene diene copolymers, polyvinyl pyridine, chlorosulfonated polyethylene, latex, polyester resins, (meth) resins, phenol resins, epoxy resins, polyvinyl alcohol, and combinations thereof.

When the aqueous binder is used as the anode binder, a cellulose-based compound capable of imparting viscosity may be further included. The cellulose-based compound may be a mixture of carboxymethylcellulose, hydroxypropyl methylcellulose, methylcellulose, or alkali metal salts thereof. The alkali metal may be Na, K, or Li.

The dry binder may be a fibrous polymeric material and may include, for example, polytetrafluoroethylene, polyvinylidene fluoride, a polyvinylidene fluoride-hexafluoropropylene copolymer, polyethylene oxide, or a combination thereof.

The conductive material serves to impart conductivity to the electrodes and may be any electronically conductive material that does not cause chemical change in the battery. Specifically, the conductive material may include, for example, carbon materials, such as natural graphite, artificial graphite, carbon black, acetylene black, Ketjen black, carbon fibers, carbon nanofibers, carbon nanotubes, and the like; metal-based materials in the form of metal powders or metal fibers containing copper, nickel, aluminum, silver, and the like; conductive polymers, such as polyphenylene derivatives and the like; or mixtures thereof.

The anode current collector may be selected from copper foil, nickel foil, stainless steel foil, titanium foil, nickel foam, copper foam, a conductive metal-coated polymer base, and combinations thereof.

### Electrolyte

The electrolyte for the lithium secondary battery 100 includes a non-aqueous organic solvent and a lithium salt.

The non-aqueous organic solvent acts as a medium through which ions involved in electrochemical reaction of a cell can move. The non-aqueous organic solvent may be a carbonate-based solvent, an ester-based solvent, an ether-based solvent, a ketone-based solvent, an alcohol-based solvent, a non-amphoteric solvent, or a combination thereof.

The carbonate-based solvents may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), and butylene carbonate (BC).

The ester-based solvents may include methyl acetate, ethyl acetate, n-propyl acetate, dimethyl acetate, methyl propionate, ethyl propionate, decanolide, mevalonolactone, valerolactone, caprolactone, and the like.

The ether-based solvents may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvents may include ethyl alcohol, isopropyl alcohol, and the like, and the non-amphoteric solvent may include nitriles, such as R—CN (where R is a straight, branched or cyclic hydrocarbon group having 2 to 20 carbon atoms and may include double bonds, aromatic rings, or ether groups); amides, such as dimethylformamide; dioxolanes, such as 1,3-dioxolane, 1,4-dioxolane, and the like; sulfolanes; and the like.

The non-aqueous organic solvent may be used alone or as a mixture thereof.

In the carbonate-based solvent, a mixture of a cyclic carbonate and a chained carbonate may be used, and the cyclic carbonate and the chained carbonate may be mixed in a volume ratio of 1:1 to 1:9.

The lithium salt is soluble in an organic solvent and serves as a source of lithium ions in a battery, enabling operation of a basic lithium secondary battery while facilitating transfer of the lithium ions between the cathode and the anode. Examples of the lithium salts include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethane sulfonate, lithium difluorobis(oxalato)phosphate (LiDFOB), and lithium bis(oxalato)borate (LiBOB).

### Separator 30

Depending on the type of lithium secondary battery 100, a separator 30 may be interposed between the cathode 10 and the anode 20. For such a separator 30, polyethylene, polypropylene, polyvinylidene fluoride, or at least two layers thereof may be used as well as mixed layers, such as a polyethylene/polypropylene bilayer separator, a polyethylene/polypropylene/polyethylene trilayer separator, a polyethylene/polyethylene/polypropylene trilayer separator, and the like.

The separator 30 may include a porous substrate and a coating layer that includes an organic material, an inorganic material, or a combination thereof on one or both surfaces of the porous substrate.

The porous substrate may be a polymer layer formed of a polymer selected from among polyolefins, such as polyethylene polypropylene, and the like, polyesters, such as polyethylene terephthalate, polybutylene terephthalate, and the like, polyacetal, polyamides, polyimides, polycarbonates, polyether ketones, polyarylether ketones, polyetherimides, polyamideimides, polybenzimidazole, polyethersulfone, polyphenylene oxides, cyclic olefin copolymers, polyphenylene sulfides, polyethylene naphthalate, glass fiber, Teflon, and polytetrafluoroethylene, copolymers thereof, or mixtures thereof.

The organic material may include a polyvinylidene fluoride polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof. But the present disclosure is not limited to these examples.

The organic material and the inorganic material may be present in a mixed state in one coating layer or may be present in the form of a stacked structure of a coating layer including the organic material and a coating layer including the inorganic material.

Referring again to FIGS. 1 to 4, as described above, the secondary battery 100 includes the electrode assembly 40 and the case 50 receiving the electrode assembly 40.

The electrode assembly 40 is formed by stacking the electrodes 10 and 20 and the separator 30. For collection of electricity from the electrode assembly 40, the secondary battery 100 further includes tabs 11, 21, 70 extending from the electrode assembly 40 and electrode leads connected to the tabs 11, 21, 70. In some embodiments, the tabs 11, 21, 70 may be formed by one or more protrusions protruding from at least one side of the electrodes 10, 20.

Upon repeated charge and discharge, the electrodes 10, 20 swell and/or shrink. When the electrodes 10, 20 undergo repeated volume expansion, cracks can be generated in the electrodes 10, 20 adjacent to the tabs 11, 21, 70. For example, in order to allow the secondary battery 100 to provide a high energy density, the anode 20 include a Si-based anode material. However, it is difficult to apply a large amount of Si to secondary batteries due to a high coefficient of expansion upon intercalation of lithium ions. In addition, upon charge/discharge of the secondary battery 100, the anode 20 can be subjected to continuous stress on the current collector near the tabs 11, 21, 70 due to large volume expansion. As a result, the secondary battery can suffer from cracking.

Hereinafter, problems that can occur upon generation of cracks in the electrodes 10, 20 will be described together with solutions to address these problems.

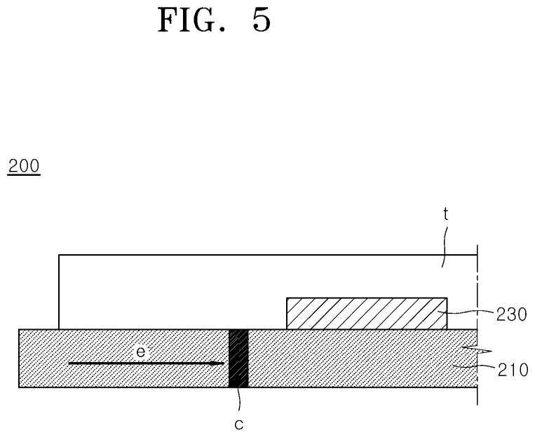

FIG. 5 is a diagram of an electron migration path when there is a crack in an electrode. More specifically, FIG. 5 illustrates a state in which cracks c are formed in an electrode 200. Here, the electrode 200 includes the cathode 10 and/or the anode 20 described in FIGS. 1 to 4. That is, the electrode 200 may be either the cathode 10 or the anode 20.

Referring to FIG. 5, the electrode 200 includes a current collector 210 and at least one tab 230, which may be, for example, the cathode lead tab 11, the anode lead tab 21, the cathode tab 71, and the anode tab 72 as illustrated in FIG. 1 to FIG. 4. The at least one tab 230 protrudes from at least one side of the current collector 210. In addition, the electrode 200 may be further provided with a tape T that protects the electrode 200. The tape T may include, for example, an insulating material.

In FIG. 5, c indicates cracks generated in the current collector 210 of the electrode 200. In addition, e⁻ indicates electrons traveling between the electrode 200 and the tab 230.

The secondary battery 100 may be charged and/or discharged as electrons move from the current collector 210 towards the tab 230 or from the tab 230 towards the current collector 210.

But cracks C can be generated in at least a portion of the electrode 200. For example, cracks can be generated in the current collector 210 adjacent to the tab 230. As a result, movement of electrons e⁻ can be restricted by the cracks. For example, electrons e⁻ cannot move from the current collector 210 towards the tab 230 or from the tab 230 towards the current collector 210, or the electrons e⁻ move inefficiently. As a result, charging and discharging efficiency of the secondary battery 100 may be deteriorated. Moreover, when the cracks c grow larger, restriction to mobility of electrons e⁻ increases, thereby further reducing utility of the secondary battery 100. Further, resistance within the secondary battery 100 increases with growth of the cracks c, and such increased resistance may cause a fire in the secondary battery 100.

The following description will focus on a solution for preventing reduction in mobility of electrons e⁻ even when cracks C are formed in a portion of the electrode 200 of the secondary battery.

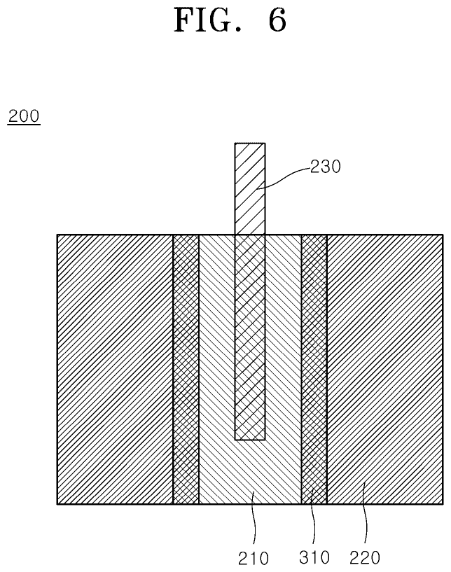

FIG. 6 is a schematic view of a secondary battery according to an embodiment of the present disclosure. As described above, the secondary battery 100 includes an electrode 200 and a tab 230 extending from at least one side of the electrode 200.

Referring to FIG. 6, the electrode 200 according to the embodiment of the disclosure includes a current collector 210 and an active material layer 220 formed on a portion of the current collector 210. A region on the current collector 210 in which the active material layer 220 is formed may be referred to as a “coated region”. Further, a region on the current collector 210 in which the active material layer 220 is not formed may be referred to as an “uncoated region”.

The tab 230 is another part of the current collector 210 and is attached to the uncoated region. In embodiments, the tab 230 has a greater length in a longitudinal direction thereof than in a width direction thereof. The tab 230 is attached at one side thereof to the current collector 210 in the longitudinal direction. In addition, the tab 230 extends from the current collector 210 in the longitudinal direction of the tab 230 such that the other side of the tab 230 is disposed outside the current collector 210. The tab 230 is electrically connected at the other side thereof to outside of the secondary battery. With this structure, the tab 230 allows electrons to travel to the electrode 200 connected to the tab 230.

The secondary battery 100 according to this embodiment further includes a reinforcing layer 210 to maintain mobility of electrons even when cracks are formed in the electrode 200.

In general, the cracks c are generated along a region in which the tab 230 is joined to the current collector 210. Cracks c are usually not formed in other regions.

Accordingly, the reinforcing layer 300 may be disposed on the electrode 200 while covering at least a portion of the tab 230. That is, the reinforcing layer 300 is disposed on at least a portion of a region in which the current collector 210 is joined to the tab 230.

The reinforcing layer 300 is disposed, for example, on at least a portion of the current collector 210. Furthermore, the reinforcing layer 300 may cover at least a portion of the active material layer 220. The reinforcing layer 300 includes a conductive layer 310 in at least a region thereof. The conductive layer 310 includes a conductive material. The conductive material is a material capable of providing an electron migration path. For example, the conductive material may include at least one of a metal, stainless steel subjected to surface treatment with a metal, a conductive polymer, carbon black, a polymer subjected to surface treatment with a metal, carbon nanotubes, graphite, and conductive pastes.

In examples, the metal of the conductive materials includes at least one of stainless steel, aluminum, nickel, nickel, titanium, calcined carbon, and copper. The stainless steel subjected to surface treatment with a metal includes stainless steel subjected to surface treatment with at least one selected from the group consisting of, for example, carbon, nickel, titanium, and silver. The conductive polymer includes at least one of polyacetylene, poly-aniline, polypyrrole, polythiophene, polymeric sulfur nitride, PEDOT (poly(3,4-ethylene dioxythiophene)), and polythiophene. The polymer subjected to surface treatment with a metal includes a polymer subjected to surface treatment with one of indium thin oxide (ITO), silver, palladium, and nickel.

Alternatively, the conductive material may include a combination of at least two of the conductive materials described above. The combination may include both two materials combined in two or more layers and two materials mixed and combined in one or more layers.

The conductive layer 310 may be formed on the current collector 210 while covering at least a portion of the tab 230. For example, the tab 230 may be partially covered by the conductive layer 310 on the current collector 210 and may be partially uncovered. Alternatively, the conductive layer 310 may be formed on the current collector 210 while covering the entirety of the tab 230. That is, with this structure, the entire region of the tab 230 may be covered by the conductive layer 310 on the current collector 210.

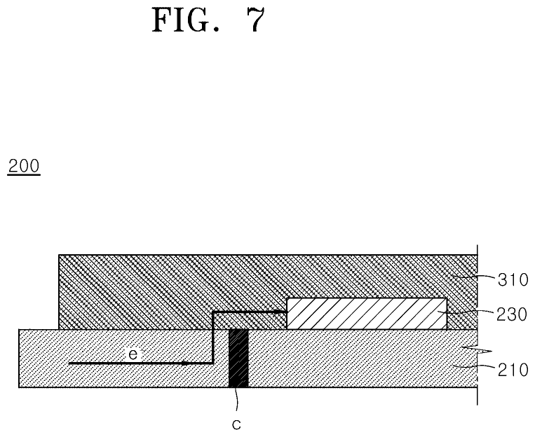

FIG. 7 is a schematic view of an electron migration path according to an embodiment of the present disclosure.

In FIG. 7, c indicates cracks generated in the current collector 210 of the electrode 200. In addition, e⁻ indicates electrons traveling between the electrode 200 and/or the tab 230.

As shown in FIG. 7, electrons e⁻ may not move to the tab 230 along the current collector 210 due to the cracks c. However, the secondary battery 100 according to embodiments of the disclosure provides a new migration path for electrons e⁻ through the conductive layer 310. Accordingly, electrons e⁻ are able to move from the current collector 210 to the tab 230 through the conductive layer 310 even when the electrons are prevented from moving through the current collector 210 to the tab 230 due to the cracks C. As such, even when a portion of the secondary battery 100 has cracks c, electrons (e⁻ ) can migrate through the conductive layer 310. Thus, the secondary battery 100 according to embodiments of the disclosure can maintain power output with or without cracks (c).

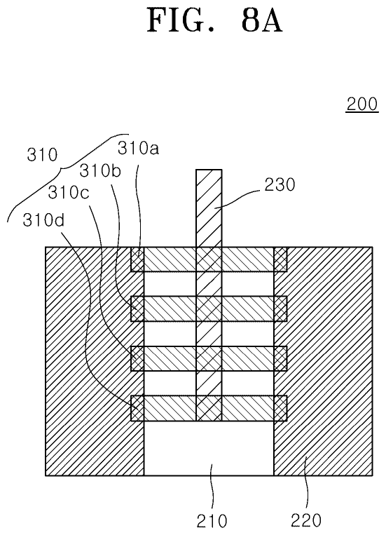

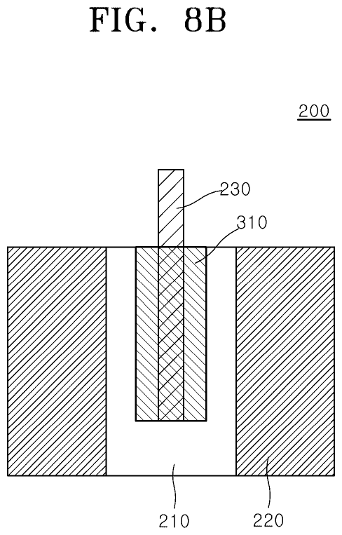

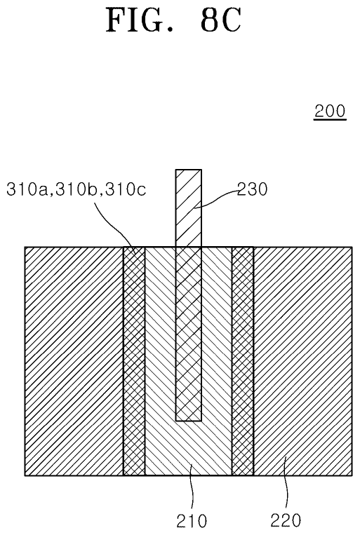

FIG. 8A to FIG. 8C are schematic views of secondary batteries according to embodiments of the present disclosure. As described above with reference to FIG. 6 and FIG. 7, the conductive layer 310 according to embodiments of the present disclosure is formed on the current collector 210 while covering at least a portion of the tab 230. FIG. 8A to FIG. 8C show various examples of such a conductive layer 310.

FIG. 8A shows an example in which the conductive layer 310 includes a plurality of conductive layers 310a, 310b, 310c, 310d spaced apart from each other. The conductive layer 310 may include a single conductive layer or a plurality of conductive layers. In the depicted example, the conductive layer 310 includes a first conductive layer 310a, a second conductive layer 310b, a third conductive layer 310c, and a fourth conductive layer 310d. Although FIG. 8A shows the conductive layer 310 including four conductive layers, the number of conductive layers is not limited thereto and the conductive layer 310 can include one or more conductive layers.

The plurality of conductive layers 310a, 310b, 310c, 310d may be arranged side-by-side at regular intervals to be spaced apart from each other or may be irregularly arranged. For example, the plurality of conductive layers 310a, 310b, 310c, 310d may be arranged side-by-side in a direction perpendicular to the longitudinal direction of the tab 230, as shown in FIG. 8A. Alternatively, the plurality of conductive layers 310a, 310b, 310c, 310d may be arranged side-by-side and/or irregularly arranged in a direction parallel to the longitudinal direction of the tab 230.

As the conductive layer 310 according to this embodiment includes the plurality of conductive layers 310a, 310b, 310c, 310d, manufacturing costs may be reduced as compared to a conductive layer composed of one large conductive layer. In addition, as the conductive layer 310 includes the plurality of conductive layers 310a, 310b, 310c, 310d, the secondary battery according to this embodiment can maintain mobility of electrons e⁻ even when cracks c are formed at any portion adjacent to the tab 230.

FIG. 8B shows an example in which the conductive layer 310 covers the entirety of the tab 230 on the current collector 210. The conductive layer 310 may include a single conductive layer that covers the tab 230. In this case, unlike the example shown in FIG. 6, the conductive layer 310 may be disposed only on the current collector 210. That is, the conductive layer 310 may cover only a region very close to the tab 230, as shown in FIG. 8B. As the conductive layer 310 is only disposed on the tab 230 and a region adjacent to the tab 230, the cost to manufacture the conductive layer 310 may be reduced and deterioration in electron mobility due to cracks c generated in the region adjacent to the tab 230 may be prevented.

FIG. 8C shows an example in which the conductive layer 310 includes a plurality of conductive layers 310a, 310b, 310c stacked one above another.

The conductive layer 310 may include a single conductive layer or a plurality of conductive layers. Although FIG. 8C shows the conductive layer 310 including three conductive layers, the number of conductive layers is not limited thereto and the conductive layer 310 may include one or more conductive layers.

The conductive layer 310 may include a first conductive layer 310a, a second conductive layer 310b, and a third conductive layer 310c, which have the same or different sizes and/or the same or different shapes. Some or all of the first conductive layer 310a, the second conductive layer 310b, and the third conductive layer 310c may be stacked one above another.

According to this embodiment, the conductive layers 310 are stacked one above another and disposed on at least a portion of the tab 230, thereby providing a migration path for electrons e- through another conductive layer even upon damage to one conductive layer. For example, if conductive layer 310a is damaged, the electrons may flow through conductive layer 210b. In addition, the secondary battery according to this embodiment allows better movement of electrons (e-) through the plurality of conductive layers 310a, 310b, 310c stacked one above another.

The secondary batteries shown in FIG. 8A to FIG. 8C are provided for illustration only. For example, the conductive layer 310 may include only one first conductive layer 310a shown in FIG. 8A. Here, the first conductive layer 310a may not be formed on the active material layer 220 to have an effective size, as shown in FIG. 8B. That is, the conductive layer 310 may be realized by any combination of the examples illustrated in FIG. 6 to FIG. 8C rather than being limited to the particular examples illustrated in FIG. 6 to FIG. 8C. As such, the conductive layer 310 is not limited in number, size and/or shape so long as the conductive layer 310 has a greater width than the tab 210 in a cross-section of the secondary battery perpendicular to the longitudinal direction of the tab 210. With this structure, the secondary battery 100 can maintain output power.

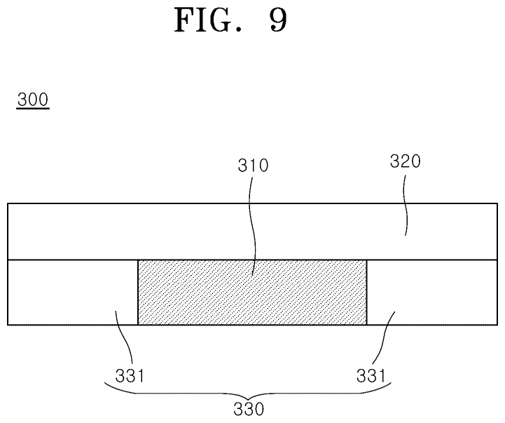

FIG. 9 is a cross-sectional view of a reinforcing layer according to an embodiment of the present disclosure.

FIG. 9 schematically shows an exemplary cross-sectional view of the reinforcing layer 300 perpendicular to the longitudinal direction of the tab 230. Referring to FIG. 9, the reinforcing layer 300 according to this embodiment may further include an insulating layer 320. The insulation layer 320 may be disposed on an upper surface of the reinforcing layer 300 such that the reinforcing layer 300 and/or a portion covered by the reinforcing layer 300 is insulated by the insulation layer 320.

The insulation layer 320 includes an insulating material. The insulating material is a material having insulating properties and may include at least one of, for example, polysulfone, polyurethane, polyamide, 6,6 Nylon, polycarbonate (PC), polytetrafluoroethylene (PTFE), polymethyl methacrylate (PMMA), polyethylene terephthalate (PET), poly (methyl methacrylate) (PMMA), and polyethylene terephthalate (PET). The insulation layer 320 thereby insulates the reinforcing layer 300 and/or a portion covered by the reinforcing layer 300 from other components.

Alternatively, the insulation layer 320 may include a material that has insulating properties and a high melting point so as to be heat resistant. For example, the insulation layer 320 may include an insulating material having a melting point of about 300° C. or higher. The insulation layer 320 may include at least one of, for example, polyimide (PI), TEFLON®, polyamide imide (PAI), polyphenylene sulfide (PPS), and polyether ether ketone (PEEK). The insulation layer 320 can thereby insulate the reinforcing layer 300 and/or a portion covered by the reinforcing layer 300 while preventing the reinforcing layer 300 and/or the portion covered thereby from deforming or catching fire.

The insulation layer 320 covers the entirety of the conductive layer 310. Accordingly, the insulation layer 320 may have a larger surface area than the conductive layer 310. In addition, the insulation layer 320 is formed on the current collector 210. Further, the insulation layer 320 may be formed to cover at least a portion of the active material layer 220 such that the current collector 210 is not exposed.

With this structure, the insulation layer 320 can prevent electrons from unintentionally escaping to outside through the conductive layer 310. In addition, the insulation layer 320 can prevent the conductive layer 210 from being exposed. As a result, the insulating layer 320 can prevent, for example, a cathode current collector and an anode current collector from contacting each other.

Referring again to FIG. 9, the reinforcing layer 300 according to this embodiment may further include an adhesive layer 330. The adhesive layer 330 secures the reinforcing layer 300 to the current collector 210. To this end, the adhesive layer 330 may be disposed between the insulation layer 320 and the current collector 210, or, alternatively, the tab 230 and/or the active material layer 220. That is, the adhesive layer 330 may be formed on a lower surface of the insulation layer 320. Here, the lower surface of the insulation layer 320 refers to a surface of the insulation layer 320 facing the current collector 210.

The adhesive layer 330 includes an adhesive material. The adhesive layer 330 includes, for example, polyurethane, epoxy, and polyolefin resins.

The adhesive layer 330 may be formed on one or both sides of the conductive layer 310. For example, the adhesive layer 330 may include a first adhesive layer 331 and a second adhesive layer 332. Here, the first adhesive layer 331 may be disposed at one side of the conductive layer 310 and the second adhesive layer 332 may be disposed at the other side of the conductive layer 310. That is, the conductive layer 310 may be secured to the insulation layer 320 on an upper surface thereof and to the current collector 210 (or the tab 230) on a lower surface thereof by the adhesive layers 331, 332 at the opposite sides of the conductive layer 310.

Alternatively, the adhesive layer 330 may be mixed with the conductive layer 310 to form a single layer, unlike the structure shown in FIG. 9. In this structure, the mixture of the conductive layer 310 and the adhesive layer 330 may have both conductive and adhesive properties. The mixture of the conductive layer 310 and the adhesive layer 330 may be disposed on the lower surface of the insulation layer 320 to allow the reinforcing layer 300 to be secured to the current collector 210 (or the tab 230 and/or the active material layer 220).

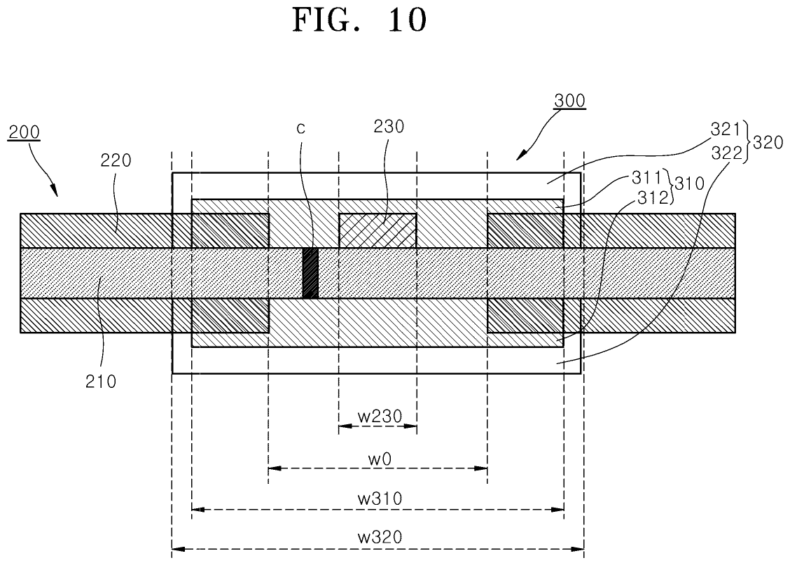

FIG. 10 is a cross-sectional view of an electrode, a tab, and a reinforcing layer according to an embodiment of the present disclosure.

FIG. 10 illustrates relative sizes of the reinforcing layer 300, the electrode 200, and the tab 230 described with reference to FIG. 6 to FIG. 9. In particular, FIG. 10 shows a cross-section of the secondary battery perpendicular to the longitudinal direction of the tab 230.

FIG. 10 illustrates an example in which the active material layer 220 is formed on at least a portion of opposite surfaces of the current collector 210 in the electrode 200. However, unlike the example shown in FIG. 10, the active material layer 220 may be formed only on one surface of the current collector 210. Further, unlike the example shown in FIG. 10, the reinforcing layer 300 may include the conductive layer 310 and the insulating layer 320 on one surface of the electrode 200 and may include only the insulating layer 320 on the other surface of the electrode 200. In this structure, a first conductive layer 311 and a first insulating layer 321 may be formed on one surface of the electrode 200, and only a second insulating layer 322 may be formed on the other surface of the electrode 200 without a second conductive layer 312.

In the cross-section perpendicular to the longitudinal direction of the tab 230 depicted in FIG. 10, w230 indicates a width of the tab 230 (hereinafter referred to as “width of the tab 230”), w0 indicates a width of the uncoated (hereinafter referred to as “width of the uncoated region”), w310 indicates a width of the conductive layer 310 (hereinafter referred to as “width of the conductive layer 310”), and w320 indicates a width of the insulation layer 320 (hereinafter referred to as “width of the insulation layer 320”). As shown in FIG. 10, the width w310 of the conductive layer 310 is greater than the width w230 of the tab 230. With such a configuration, the conductive layer 310 allows electrons to move between the tab 230 and the current collector 210 through the conductive layer 310 even when cracks c are formed near the tab 230.

As also shown in FIG. 10, the width w310 of the conductive layer 310 is less than or equal to the width w320 of the insulation layer 320. For example, the width w310 of the conductive layer 310 may be the same as the width w320 of the insulation layer 320, and, as another example, the conductive layer 310 and the insulation layer 320 may have the same area. With this configuration, the conductive layer 310, the insulating layer 320, and/or the reinforcing layer 300 may easily be formed. Alternatively, for example, the width w310 of the conductive layer 310 may be less than the width w320 of the insulating layer 320, and, as another example, the conductive layer 310 may have a smaller surface area than the insulating layer 320. With this configuration, the secondary batteries can be manufactured at a reduced cost while providing the conductive layer 310 to be insulated from outside by the insulation layer 320.

As shown in FIG. 10, the width w320 of the insulation layer 320 is greater than or equal to the width w0 of the uncoated region. For example, the insulation layer 320 may cover the entirety of the uncoated region and, the insulation layer 320 may cover at least a portion of the coated region. With this structure, the insulation layer 320 prevents the current collector 210 from contacting a current collector with the other polarity. For example, the insulation layer 320 prevents the cathode current collector and the anode current collector from contacting each other.

The secondary batteries 100 each including the reinforcing layer 300 have been described with reference to FIG. 6 to FIG. 10. With these structures, the secondary batteries 100 according to the embodiments of the present disclosure can maintain output power by enabling electron migration even when cracks c are formed in the electrode 200.

Although the present disclosure has been described with reference to embodiments and drawings illustrating aspects thereof, the present disclosure is not limited thereto. Various modifications and variations can be made by a person skilled in the art to which the present disclosure belongs.

### LIST OF REFERENCE NUMERALS

100: Secondary battery
200: Electrode
210: Current collector
220: Active material layer
230: Tab
300: Reinforcing layer
310: Conductive layer

What is claimed is:

1. A secondary battery comprising:
a current collector;
an active material layer formed on a first portion of the current collector;
a tab attached to a second portion of the current collector; and
a reinforcing layer disposed on the current collector while covering at least a portion of the tab,
wherein the reinforcing layer comprises a conductive layer comprising a conductive material.

2. The secondary battery according to claim 1, wherein the conductive layer covers at least a portion of the tab on the current collector.

3. The secondary battery according to claim 1, wherein the conductive layer is formed on the current collector to cover the entirety of the tab.

4. The secondary battery according to claim 1, wherein the conductive material comprises at least one of a metal, stainless steel subjected to surface treatment with a metal, a conductive polymer, carbon black, a polymer subjected to surface treatment with a metal, carbon nanotubes, graphite, and conductive pastes.

5. The secondary battery according to claim 1, wherein, in a cross-section perpendicular to a longitudinal direction of the tab, the conductive layer has a greater width than the tab.

6. The secondary battery according to claim 1, wherein the reinforcing layer further comprises an insulating layer comprising an insulating material, the insulating layer being formed on the current collector and covering the conductive layer.

7. The secondary battery according to claim 6, wherein the conductive layer has a surface area less than or equal to a surface area of the insulating layer.

8. The secondary battery according to claim 6, wherein, in a cross-section perpendicular to a longitudinal direction of the tab, the conductive layer has a width less than or equal to a width of the insulating layer.

9. The secondary battery according to claim 6, wherein, in a cross-section perpendicular to a longitudinal direction of the tab, the insulating layer has a width greater than or equal to a width of another portion of the current collector.

10. The secondary battery according to claim 6, wherein the insulation layer comprises at least one selected from the group consisting of polyimide, polytetrafluoroethylene, polyamide imide, polyphenylene sulfide, and polyether ether ketone.

11. The secondary battery according to claim 1, wherein the reinforcing layer further comprises an adhesive layer securing the reinforcing layer to the current collector.

12. The secondary battery according to claim 11, wherein the adhesive layer comprises at least one of polyurethane, epoxy, and polyolefin resins.

13. A secondary battery comprising:
an electrode assembly formed by stacking an electrode and a separator;
a tab protruding from a side of the electrode;
a reinforcing layer disposed on the electrode, with the reinforcing layer covering at least a portion of the tab;
an electrode lead connected to the tab; and
a case accommodating the electrode assembly,
wherein the reinforcing layer comprises a conductive layer comprising a conductive material,
wherein the electrode comprises a current collector and an active material layer formed on a first portion of the current collector, and
wherein the tab is attached to a second portion of the current collector and extends from the electrode assembly.

14. The secondary battery according to claim 13, wherein the conductive layer covers at least a portion of the tab on the current collector.

15. The secondary battery according to claim 13, wherein the conductive layer is formed on the current collector to cover the entirety of the tab.

16. The secondary battery according to claim 13, wherein, in a cross-section perpendicular to a longitudinal direction of the tab, the conductive layer has a greater width than the tab.

17. The secondary battery according to claim 13, wherein, in a cross-section perpendicular to a longitudinal direction of the tab, the reinforcing layer further comprises an insulating layer comprising an insulating material and formed on the current collector to cover the conductive layer.

18. The secondary battery according to claim 17, wherein the conductive layer has a surface area less than or equal to a surface area of the insulating layer.

19. The secondary battery according to claim 17, wherein, in a cross-section perpendicular to a longitudinal direction of the tab, the conductive layer has a width less than or equal to a width of the insulating layer.

20. The secondary battery according to claim 17, wherein, in a cross-section perpendicular to a longitudinal direction of the tab, the insulating layer has a width greater than or equal to a width of another portion of the current collector.
